(19) United States
(12) Patent Application Publication
(10) Pub. No.: US 2014/0356673 A1
(43) Pub. Date: Dec. 4, 2014

(54) SECONDARY BATTERY

(71) Applicant: Samsung SDl Co., Ltd., Yongin-si (KR)

(72) Inventors: Soon-Rewl Lee, Yongin-si (KR); Ick-Kyu Choi, Yongin-si (KR); Young-Ki Kim, Yongin-si (KR); Young-Hun Lee, Yongin-si (KR); Na-Ri Park, Yongin-si (KR); Yong-Chul Park, Yongin-si (KR)

(73) Assignee: Samsung SDl Co., Ltd., Yongin-si (KR)

(21) Appl. No.: 14/276,929

(22) Filed: May 13, 2014

(30) Foreign Application Priority Data
May 29, 2013 (KR) 10-2013-0061176

(51) Int. Cl. H01M 10/0587; H01M 10/0525; H01M 4/525; H01M 4/36; H01M 4/131

(52) U.S. Cl. CPC H01M 10/0587; H01M 4/366; H01M 4/131; H01M 4/525; H01M 10/0525
USPC 429/94; 429/217; 429/163

(57) ABSTRACT

There is provided a secondary battery which can implement a high-density electrode plate and prevent fracture of the electrode plate. The secondary battery includes a metallic base material, a first active material coated on one surface of the metallic base material, and a second active material coated on the other surface of the metallic base material. In the secondary battery, the difference in loading level between the first and second active materials ranges from 2 mg/cm² to 10 mg/cm².

### CROSS-REFERENCE TO RELATED APPLICATIONS

This application claims priority to and the benefit of Korean Patent Application No. 10-2013-0061176, filed on May 29, 2013, in the Korean Intellectual Property Office, the entire contents of which are incorporated herein by reference in their entirety.

### BACKGROUND

1. Field

An aspect of the present invention relates to a secondary battery, and more particularly, to a secondary battery capable of implementing a high-density electrode plate.

2. Description of the Related Technology

In a lithium secondary battery, the battery is manufactured with a material having lithium ions reversibly inserted thereinto and separated therefrom is used for positive and negative electrodes, and an organic or polymer electrolyte is charged between the positive and negative electrodes.

The lithium secondary battery generates electrical energy through an oxidation-reduction reaction when lithium ions are inserted/separated into/from the positive and negative electrodes. Since the lithium ion has a high electrochemical standard potential, the lithium secondary battery can obtain a high battery voltage and a large energy density.

Lithium-transition metal oxide is used as a positive electrode active material of the lithium secondary battery, and carbon (crystalline or amorphous), carbon complex, lithium metal or lithium alloy is used as a negative electrode active material.

After each of the positive and negative electrodes is formed by coating the active material to an appropriate thickness and length on a collector or forming the active material in a film shape, an electrode assembly is formed by winding or stacking the positive and negative electrodes together with a separator as an insulator. Then, the electrode assembly is accommodated in a can or container similar thereto, and an electrolyte is injected into the can or container, thereby manufacturing a prismatic lithium secondary battery.

In order to implement a high-density electrode plate for developing a high-capacity lithium secondary battery, an attempt has been made to improve the grain shape and distribution of active materials and to control the ratio of a conductive agent and a binder. However, there occurs a phenomenon that the electrode plate can fracture at a high loading level.

### SUMMARY OF CERTAIN INVENTIVE ASPECTS

Embodiments provide a secondary battery which can implement a high-density electrode plate and prevent fracture of the electrode plate.

According to an aspect of the present invention, there is provided a secondary battery, including: a first metallic base material; a first active material coated on one surface of the the first metallic base material; and a second active material coated on the other surface of the first metallic base material, wherein the first metallic base material and the first and second active materials define a first electrode plate of the secondary battery and wherein the difference in loading level between the first and second active materials ranges from 2 mg/cm² to 10 mg/cm².

The loading level of the first active material may range from 20 mg/cm² to 45 mg/cm². The loading level of the second active material may range from 18 mg/cm² to 43 mg/cm².

The first or second active material may be at least one selected from the group consisting of LCO, NCM and NCA.

The first and second active materials may be positive active materials.

The metallic base material may include aluminum (Al).

According to the present invention, active materials having different loading levels are respectively coated on both surfaces of a metallic base material used in an electrode plate, and the active material having a relatively high loading level becomes an outer surface of the electrode plate, so that it is possible to manufacture a secondary battery in which a high-density electrode plate having a high loading level is implemented, and the electrode plate is not easily fractured.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a view schematically showing the structure of a secondary battery according to an embodiment of the present invention.

FIG. 2 is a view schematically showing the structure of an electrode plate before being wound in the secondary battery according to the embodiment of the present invention.

FIG. 3 is a view schematically showing the structure of the electrode plate after being wound in the secondary battery according to the embodiment of the present invention.

### DETAILED DESCRIPTION OF CERTAIN INVENTIVE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to other element or be indirectly connected to the other element with one or more intervening elements interposed therebetween. Hereinafter, like reference numerals refer to like elements. In the drawings, the thickness or size of layers are exaggerated for clarity and not necessarily drawn to scale.

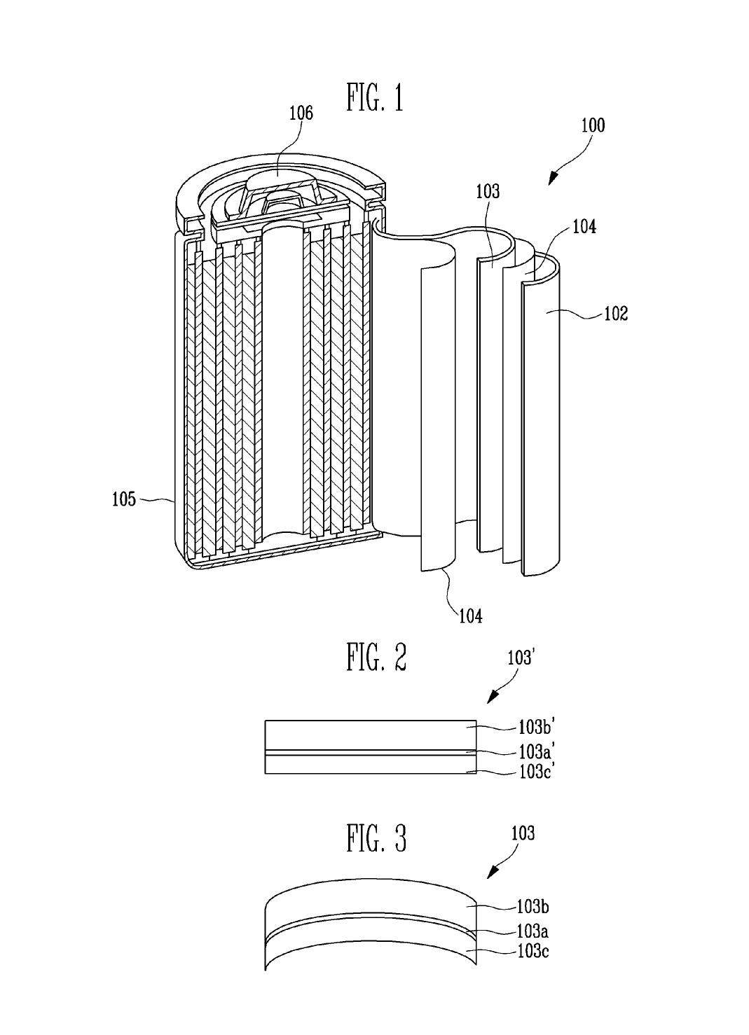

FIG. 1 is a view schematically showing the structure of a secondary battery according to an embodiment of the present invention. FIG. 2 is a view schematically showing the structure of an electrode plate before being wound in the secondary battery according to the embodiment of the present invention. FIG. 3 is a view schematically showing the structure of the electrode plate after being wound in the secondary battery according to the embodiment of the present invention.

Referring to FIG. 1, the secondary battery 100 according to this embodiment includes, as main parts, a first electrode plate 102, a second electrode plate 103 or 103′, a separator 104 disposed between the first electrode plate 102 and the second electrode plate 103 or 103′, an electrolyte (not shown) immersed in the first electrode plate 102, the second electrode plate 103 or 103′ and the separator 104, a battery container 105, and a sealing member 106 configured to seal the battery container 105.

When assuming that the first electrode plate 102 is a negative electrode plate and the second electrode plate 103 or 103′ is a positive electrode plate, ions or electrons move between the first electrode plate 102 and the second electrode plate 103 or 103′, thereby generating electrochemical energy.

The first electrode plate 102 may be formed by coating a negative electrode active material on a single surface or both surfaces of a negative electrode metallic base material (not shown). The negative electrode base material may be a conductive metal, and the negative electrode active material may include graphite, etc.

The second electrode plate 103 or 103′ may be formed by respectively coating a first active material 103b or 103b′ and a second active material 103c or 103c′ on both surfaces of a positive electrode metallic base material 103a or 103a′. Generally, the positive electrode metallic base material 103a or 103a′ is a material having high conductivity. In an embodiment of the present invention, aluminum (Al) is used as an example of the positive electrode metallic base material 103a or 103a′. However, the positive electrode metallic base material 103a or 103a′ is not limited thereto. That is, the positive electrode metallic base material 103a or 103a′ is not particularly limited as long as it does not cause a chemical change. The positive electrode active material may include a layered compound containing lithium.

The separator 104 may be interposed between the first electrode plate 102 and the second electrode plate 103 or 103′ in order to prevent the first electrode plate 102 and the second electrode plate 103 or 103′ from being short-circuited by coming in direct contact with each other when the first electrode plate 102 and the second electrode plate 103 or 103′ have polarities opposite to each other. For example, the separator 104 may be formed of a polymer material. The separator 104 may include an insulative thin film having high ion transmittance and mechanical strength.

The electrolyte (not shown) accommodated in the battery container 105 may include a lithium salt that acts as a supply source of lithium ions, and a non-aqueous organic solvent that serves as a medium through which ions participating in an electrochemical reaction can move. The first electrode plate 102 and the second electrode plate 103 or 103′ may generate electrochemical energy through a reaction with the electrolyte. The generated electrochemical energy may be transferred to the outside of the secondary battery through an electrode tab (not shown). The secondary battery 100 of the present invention may be manufactured by winding the first electrode plate 102, the second electrode plate 103 or 103′ and the separator 104, but the present invention is not limited thereto. That is, the secondary battery 100 may be manufactured by various methods such as a method of stacking the first electrode plate 102, the second electrode plate 103 or 103′ and the separator 104.

Referring to FIGS. 2 and 3, the secondary battery 100 according to this embodiment includes a metallic base material 103a or 103a′, a first active material 103b or 103b′ coated on one surface of the metallic base material 103a or 103a′, and a second active material 103c or 103c′ coated on the other surface of the metallic base material 103a or 103a′. An electrode plate in which the difference in loading level between the first active material 103b or 103b′ and the second active material 103c or 103c′ ranges from 2 mg/cm² to 10 mg/cm² is used as the second electrode plate 103 or 103′.

Here, the loading level of the first active material 103b or 103b′ preferably ranges from 20 mg/cm² to 45 mg/cm². Meanwhile, the loading level of the second active material 103c or 103c′ preferably ranges from 18 mg/cm² to 43 mg/cm².

In a case where the secondary battery is a prismatic polymer secondary battery, the sum of the loading levels of the first and second active materials 103b or 103b′ and 103c or 103c′ may range from 40 mg/cm² to 50 mg/cm². In a case where the secondary battery is a cylindrical secondary battery, the sum of the loading levels of the first and second active materials 103b or 103b′ and 103c or 103c′ may be approximately 60 mg/cm² or more.

The first electrode plate 102 (see FIG. 1), the second electrode plate 103 or 103′ and the separator may be wound, thereby manufacturing an electrode assembly. In this case, there may occur a problem in that the first and second active materials 103b or 103b′ and 103c or 103c′ are separated from the second electrode plate 103 or 103′ during the winding of the second electrode plate 103 or 103′. Since the second electrode plate 103 or 103′ has influence on the capacity of the secondary battery, the second electrode plate 103 or 103′ advantageously has a mixture density as high as possible so that the secondary battery has high capacity per unit volume. Thus, the difference in loading level between the first active material 103b or 103b′ and the second active material 103c or 103c′ preferably ranges from 2 mg/cm² to 10 mg/cm², so that the second electrode plate 103 or 103′ has high mixture density as high as possible, and simultaneously, the first and second active materials 103b or 103b′ and 103c or 103c′ are not separated from the second electrode plate 103 or 103′ or fractured (during the winding of the second electrode plate 103 or 103′).

In a case where the difference in loading level between the first active material 103b or 103b′ and the second active material 103c or 103c′ is less than 2 mg/cm², there may occur a problem in that, when the second electrode plate 103 or 103′ is provided to have a predetermined mixture density, the first and second active materials 103b or 103b′ and 103c or 103c′ are separated from the second electrode plate 103 or 103′ during the winding of the second electrode plate 103 or 103′. In a case where the difference in loading level between the first active material 103b or 103b′ and the second active material 103c or 103c′ exceeds 10 mg/cm², deformation or the like may occur during the winding of the second electrode plate 103 or 103′ due to non-uniform thickness of the second electrode plate 103 or 103′. Further, a desired capacity of the secondary battery may not be obtained due to non-uniform movement of ions between the second electrode plate 103 or 103′ and the first electrode plate opposite thereto is non-uniform, and the reliable performance of the secondary battery may be problematic. In addition, the surface of the active material having a relatively high loading level is weak against tension, and therefore, the active material may be easily fractured during the winding of the second electrode plate.

Here, the first or second active material may be at least one selected from the group consisting of LOC, NCM and NCA. The first and second active materials may be positive electrode active materials. The metallic base material 103a or 103a′ may be made of Al.

Referring to FIG. 2, the second electrode plate 103′ of the secondary battery 100 according to this embodiment is formed so that the loading level of the first active material 103b′ coated on the one surface of the metallic base material 103a′ is different from that of the second active material 130c′ coated on the other surface of the metallic base material 103a′. Specifically, the second electrode plate 103′ is formed so that the loading level of the first active material 103b′, which becomes an outer surface of the second electrode plate 103′ when the second electrode plate 103′ is wound, is higher than that of the second active material 103c′. Subsequently, the second electrode plate 103′ is dried, and a press process is performed on the second electrode plate 103′.

FIG. 3 is a view showing a direction in which the second electrode plate 103 is wound in order to manufacture the electrode assembly. As described above, the electrode assembly is manufactured by winding the second electrode plate 103 (together with the first electrode plate and the separator) so that the first active material 103b coated on the one surface of the metallic base material 103a so as to have a high loading level becomes an outer surface of the second electrode plate 103 and the second active material 103c having a relatively low loading level becomes an inner surface of the second electrode plate 103. In this case, although the press process is performed on the second electrode plate 103 so that the first active material having the high loading level becomes a high-density active material, the fracture of the second electrode plate 103 is less likely to occur.

### Embodiment 1

A positive electrode active material was prepared in a slurry state by mixing 96 wt % positive electrode active materials (first and second active materials) containing a lithium compound, 2.0 wt % polyvinylidene fluoride high-flexible polymer and 2.0 wt % carbon black conducting agent in an N-methyl pyrrolidone solvent. The positive electrode active materials prepared in the slurry state as described above were respectively coated on both surfaces of an Al base material used as a collector so that the loading levels of the positive electrode active materials are different from each other. The positive electrode materials were coated and then dried at 120° C., thereby manufacturing a positive electrode plate (second electrode plate). In this case, the loading level of the positive electrode plate was 50 mg/cm². The positive electrode plate was manufactured by coating the positive electrode active material having a loading level of 24 mg/cm² on one surface (surface A) of the flat Al base material and coating the positive electrode active material having a loading level of 26 mg/cm² on the other surface (surface B) of the Al base material. The manufactured positive electrode plate was dried in a vacuum chamber at 100° C. for five hours. The positive electrode plate was wound together with a negative electrode plate and a separator, thereby manufacturing an electrode assembly. In this case, the surface A having a relatively low loading level was provided to become an inner surface of the positive electrode plate with respect to the winding direction.

### Embodiment 2

A positive electrode plate was manufactured identically to that of Embodiment 1, except that the positive electrode active material having a loading level of 23 mg/cm² was coated on the one surface (surface A) of the Al base material, and the positive electrode active material having a loading level of 27 mg/cm² was coated on the other surface (surface B) of the Al base material.

### Comparative Example

A positive electrode plate was manufactured identically to that of Embodiment 1, except that the positive electrode active material having a loading level of 24.5 mg/cm² was coated on the one surface (surface A) of the Al base material, and the positive electrode active material having a loading level of 24.5 mg/cm² was coated on the other surface (surface B) of the Al base material.

Referring to Table 1, the entire loading level obtained by adding the loading levels of the surfaces A and B was 50 mg/cm² in Embodiment 1, Embodiment or Comparative Example. On the other hand, the difference in loading level between the surfaces A and B was 2 mg/cm² in Embodiment 1, and the difference in loading level between the surfaces A and B was 5 mg/cm² in Embodiment 2. However, the difference in loading level between the surfaces A and B was 1 mg/cm² in Comparative Example. In a case where the positive electrode plate manufactured as described above was wound together with the negative electrode plate and the separator, there occurred a phenomenon that the positive electrode plate was fractured in Comparative Example. Therefore, the winding of the positive electrode plate manufactured in Comparative Example was difficult, and hence it was difficult to manufacture an electrode assembly. Accordingly, it was impossible to identify capacity, lifespan, etc.

When comparing Embodiment 1 with Embodiment 2, the mixture density in Embodiment 1 was 3.85 mg/cm³, but the mixture density in Embodiment 2 was 3.95 mg/cm³. Embodiment 2 in which the difference in loading level was 5 mg/cm² could be implemented to have a mixture density higher than that of Embodiment 1 in which the difference in loading level was 2 mg/cm². Further, it can be seen that Embodiment 2 has an effect relatively better than that of Embodiment 1 in terms of capacity and lifespan.

Although it has been described in this embodiment that the cylindrical secondary battery is used as an example, it will be apparent that secondary batteries with other types may be used.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
a first metallic base material;
a first active material coated on one surface of the first metallic base material; and
a second active material coated on the other surface of the first metallic base material,
wherein the first metallic base material and the first and second active materials define a first electrode plate of the secondary battery and wherein the difference in loading level between the first and second active materials ranges from 2 mg/cm² to 10 mg/cm².

2. The secondary battery of claim 1, wherein the loading level of the first active material ranges from 20 mg/cm² to 45 mg/cm².

3. The secondary battery of claim 1, wherein the loading level of the second active material ranges from 18 mg/cm² to 43 mg/cm².

4. The secondary battery of claim 1, wherein the first or second active material is at least one selected from the group consisting of LCO, NCM and NCA.

5. The secondary battery of claim 4, wherein the first and second active materials are positive electrode active materials.

6. The secondary battery of claim 1, wherein the first metallic base material includes aluminum (Al).

7. The secondary battery of claim 1, further comprising second metallic base material that has a third active material coating the second metallic base material that define a second electrode plate of the secondary battery that is complementary to the first electrode.

8. The secondary battery of claim 7, further comprising a separator interposed between the first and second electrode plates and a case that contains the first and second electrodes.

9. The secondary battery of claim 8, wherein an electrolyte is positioned within the case.

10. The secondary battery of claim 1, wherein the first electrode.

11. The secondary battery of claim 8, wherein the first and second electrode plates are wound together and the first active material is positioned so as to be on the outer side of first metallic base material towards the inner walls of the case.
